(19) United States
(12) Patent Application Publication
(10) Pub. No.: US 2008/0125944 A1
(43) Pub. Date: May 29, 2008

(54) VEHICLE CONTROL APPARATUS

(75) Inventors: Hirofumi KAMISHIMA, Toyota-shi (JP); Masayasu Mizobuchi, Aichi-gun (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 11/943,787

(22) Filed: Nov. 21, 2007

(30) Foreign Application Priority Data
Nov. 24, 2006 (JP) 2006-316968

(51) Int. Cl. B60W 30/18; B60W 10/06; B60W 10/10; B60W 10/18

(52) U.S. Cl. 701/54

(57) ABSTRACT

A vehicle control apparatus according to an embodiment of the present invention involves a neutral control unit that executes a neutral control that sets power transmission of the forward clutch to not more than a predetermined value while the vehicle is stopped, a brake hold control unit that executes a brake hold control that preserves braking force of the vehicle regardless of operation of a brake pedal, and an engine torque control unit that, in a circumstance in which the neutral control is being executed during execution of the brake hold control, when there has been a demand to start forward vehicle movement, starts a return from the neutral control, and when returning from the neutral control, smoothly increases the engine torque of the internal combustion engine regardless of an accelerator opening degree.

### BACKGROUND OF THE INVENTION

1. Field of the Invention

The present invention relates to a control apparatus for a vehicle equipped with an internal combustion engine (below, also referred to as an engine) and an automatic transmission. More specifically, the present invention relates to a vehicle control apparatus that executes a neutral control that puts an automatic transmission of a stopped vehicle into a neutral state, and a brake hold control that maintains braking force of the vehicle regardless of operation of a brake pedal by a driver.

2. Description of the Related Art

In an engine installed in a vehicle, electronic throttle systems are known in which an actuator is provided that drives a throttle valve provided in an intake path, the electronic throttle system enabling control of a throttle opening degree independent of operation of an accelerator pedal by a driver. In an electronic throttle system, the throttle opening degree is controlled so as to obtain an optimum air intake amount (a target intake amount) according to the operating state of the engine, such as the number of engine revolutions and the amount of accelerator pedal depression (accelerator opening degree) by the driver. In this sort of electronic throttle system, the actual throttle opening degree of the throttle valve is detected using a throttle opening degree sensor or the like, and feedback control is performed for the actuator of the throttle valve such that the actual throttle opening degree matches the throttle opening degree obtained by the above target intake amount (target throttle opening degree).

As vehicle braking systems, electronically controlled brake (ECB) systems that control wheel brake pressure independent of operation of a brake pedal by a driver are known. In a vehicle equipped with an electronically controlled brake system, with an object of improving driver convenience, a control is performed that maintains the vehicle brake pressure after the vehicle is stopped, even if the driver removes their foot from the brake pedal (below, referred to as brake hold control). This brake hold control is removed when the accelerator pedal enters an ON state, and thus the wheel brake pressure is released.

Also, cruise control is known as an example of vehicle speed control. Cruise control is a system with objects of, for example, improving safety and reducing driver operating effort when running on highways or the like. With this cruise control, a fixed speed running mode or the like is set in which, by controlling driving force and braking force that is applied to the vehicle such that the vehicle speed matches a set vehicle speed (target vehicle speed) that the driver has set in advance, the vehicle is caused to cruise at the set vehicle speed.

Moreover, recently there have been developments in a radar cruise control with an all vehicle speed-following function (below, referred to as all vehicle speed cruise control). The all vehicle speed cruise control is a driving support system that, when the vehicle is running on a highway or a road for automobiles only, in a wide range from 0 km/h to about 100 km/h, runs the vehicle so as to follow a preceding vehicle while keeping an appropriate inter-vehicle distance from the preceding vehicle. With this all vehicle speed cruise control, it is possible to lighten the driver's burden of operating the accelerator or the brake not only during running at a fixed speed, but also in a situation such as stop-and-go driving when there is heavy traffic. Moreover, when the preceding vehicle that is being followed has stopped, a stopped state is maintained that keeps an appropriate inter-vehicle distance, and when recognizing that the preceding vehicle has started to move again, it is possible to resume running following the preceding vehicle by the driver operating a switch (operating a resume lever) or operating the accelerator pedal.

In this sort of all vehicle speed cruise control, the above-described electronic throttle system and electronically controlled brake system are employed in control of the driving force and braking force applied to the vehicle.

On the other hand, in a vehicle equipped with an engine, an automatic transmission that automatically optimally sets a gear ratio between the engine and driving wheels is known as a transmission that appropriately transmits rotational velocity and torque generated by the engine to the driving wheels, according to the running state of the vehicle.

Examples of automatic transmissions installed in a vehicle include a planetary gear-type transmission employing a clutch and brake and a planetary gear apparatus, and a belt-type gearless transmission that gearlessly adjusts the gear ratio (CVT: continuously variable transmission). With a belt-type gearless transmission, it is possible to effectively draw out engine output, and thus improvement of fuel economy and running performance are excellent.

In a vehicle equipped with an automatic transmission, ordinarily, a shift lever operated by the driver is provided, and by operating the shift lever, it is possible to switch a shift position of the automatic transmission, for example to a P range (parking range), an R range (rearward running range), an N range (neutral range), a D range (frontward running range), or the like.

In a vehicle equipped with this sort of automatic transmission, for example in a state in which the D range has been set and the vehicle is stopped, driving force from the idling engine is transmitted to the automatic transmission via a torque converter, and this is transmitted to the driving wheels, causing a so-called creeping phenomenon to occur. The creeping phenomenon is very useful under predetermined conditions; for example, it is possible to smoothly begin moving forward when the vehicle is stopped on a sloped road (when ascending). However, this phenomenon is not wanted when it is desired to maintain a stopped state of the vehicle, and in this case, creeping force is suppressed by operating the brakes of the vehicle. That is, the creeping force of the engine is suppressed by the braking force, and there is the problem that to that extent, the engine fuel economy is reduced.

Therefore, a neutral control is executed in which, when a predetermined neutral control start condition has been established, for example a condition that “with the shift position of the automatic transmission in D range, without an accelerator operation being performed, a brake operation is performed, and the vehicle is in a stopped state”, with the automatic transmission remaining in D range, a neutral state near neutral is entered, thus achieving an improvement in fuel economy (for example, see JP 2004-183608A). Neutral control means a control that releases a forward clutch of the automatic transmission or puts the forward clutch in a predetermined slip state, thus establishing a state near neutral.

In a vehicle control apparatus that executes this sort of neutral control and the above-described brake hold control, execution of the neutral control during the brake hold control in order to improve fuel economy in practical use is being investigated. Also in a vehicle provided with the above all vehicle speed cruise control, likewise, execution of the neutral control during the brake hold control is being investigated.

As technology related to the neutral control, for example, the technology disclosed in JP S62-244725A is known, and as technology related to the brake hold control, for example the technology disclosed in JP 2003-2087A is known.

Incidentally, when the neutral control is executed during execution of the brake hold control, because it is necessary to return from the neutral control with accelerator pedal ON as a trigger, there is the problem that a shock occurs at the time of return from the neutral control, reducing drivability. Also during execution of the all vehicle speed cruise control, return from the neutral control during execution of the brake hold control is performed with accelerator ON or operation of the resume lever as a trigger, so a shock occurs when returning from the neutral control. These points are described below.

First, when returning from ordinary neutral control, the return from the neutral control is started with the driver removing their foot from the brake pedal (brake pedal OFF) as a trigger, so when the driver steps on the accelerator pedal, the return from the neutral control (engagement of the forward clutch) is generally finished, and thus smooth acceleration is possible.

On the other hand, when the brake hold control and the neutral control are executed at the same time (including when the all vehicle speed cruise control is executed), there may be an instance when the driver's foot is removed from the brake pedal while the vehicle is stopped, so it is not possible to use the ordinary trigger “brake pedal OFF” as the trigger for returning from the neutral state. Therefore, the return from the neutral control is started using accelerator ON (or operation of the resume lever) as a trigger. When, in this manner, the return from the neutral control is performed using accelerator pedal ON (or operation of the resume lever) as a trigger, it is not possible to obtain the brake pedal release time or the like that is present in a return from the ordinary neutral control. Thus, it is necessary to engage the forward clutch of the automatic transmission in a state in which the accelerator is operated ON by the driver. However, because it is difficult to adapt hydraulics of the forward clutch to match the engine torque, which changes variously depending on how the accelerator pedal is depressed, a shock occurs when returning from the neutral control.

Also, when the brake hold control and the neutral control are executed at the same time, if the return from the neutral control is performed using accelerator ON as a trigger, the return from the brake hold control is also performed at the same time by that accelerator ON. When, in this manner, the start of the return from the neutral control and the return from the brake hold control (the start of the release of brake pressure) are performed at the same time, the brake pressure is released earlier than the engagement of the forward clutch of the automatic transmission, so when the vehicle begins moving forward on a sloped road (when ascending), there is a risk that it will not be possible to obtain adequate creeping force, and the vehicle will move backward.

### SUMMARY OF THE INVENTION

The present invention was made in consideration of such circumstances, and it is an object thereof to provide a vehicle control apparatus that, in a circumstance in which a neutral control is being executed during execution of a brake hold control, when returning from the neutral control in response to a demand to start forward vehicle movement, is capable of suppressing a shock when returning from the neutral control.

The present invention provides a control apparatus for a vehicle comprising an internal combustion engine and an automatic transmission having a forward clutch that is engaged when the vehicle starts moving forward, the vehicle control apparatus including a neutral control unit that executes a neutral control that sets power transmission of the forward clutch to not more than a predetermined value while the vehicle is stopped, a brake hold control unit that executes a brake hold control that preserves braking force of the vehicle regardless of operation of a brake pedal, and an engine torque control unit that, in a circumstance in which the neutral control is being executed during execution of the brake hold control, when there has been a demand to start forward vehicle movement, starts a return from the neutral control, and when returning from the neutral control, smoothly increases the engine torque of the internal combustion engine regardless of an accelerator opening degree.

According to the present invention, it is possible to suppress an early increase in the engine torque of the internal combustion engine when returning from the neutral control, so controllability of the forward clutch of the automatic transmission is improved. Thus, it is possible to suppress a shock when returning from the neutral control.

In the present invention, it is preferable that the start of increasing the engine torque of the internal combustion engine is delayed for a predetermined length of time after the point in time that there was a demand to start forward vehicle movement. Also, it is preferable that a slope of the increase in the engine torque of the internal combustion engine (for example, a slope of the increase in a throttle opening degree) is limited to not more than a predetermined value. By adopting such a configuration, it is possible to more effectively suppress a shock when returning from the neutral control.

In the present invention, it is preferable to preserve braking force of the vehicle when returning from the neutral control, thus preventing backward movement of the vehicle when returning from the neutral control. Also, it is preferable that during the return from the neutral control, braking force is smoothly released by limiting a slope of release of braking force to not more than a predetermined value.

In the present invention, it is preferable to start releasing braking force at a point in time delayed for a predetermined length of time from the point in time that there was a demand to start forward vehicle movement (the point in time of starting the return from the neutral control). By, in this manner, not starting the release of braking force immediately after starting the return from the neutral control, but rather, starting to release braking force at a point in time that a predetermined length of time has passed since starting the return, it is possible to preserve brake pressure until the forward clutch has adequate engaging force to prevent backward vehicle movement, and thus it is possible to more reliably prevent backward movement when the vehicle begins moving forward on a sloped road (when ascending).

Also, examples of other methods for setting the timing for starting the release of brake pressure include starting the release of brake pressure according to engagement pressure of the forward clutch, and starting the release of brake pressure according to a speed ratio [Nt/Ne] of a number of turbine revolutions Nt of a torque converter provided in the automatic transmission and a number of engine revolutions Ne of the internal combustion engine.

### BRIEF DESCRIPTION OF THE DRAWINGS

FIG. 1 is a schematic configuration diagram that shows an example of a vehicle control apparatus according to the present invention.

FIG. 2 is an operation table for an automatic transmission shown in FIG. 1.

FIG. 3 is a block diagram that shows the configuration of a control system of an ECU and the like.

FIG. 4 is a flow chart that shows processing content of a forward movement start control.

FIG. 5 is a timing chart that shows operation of the forward movement start control.

FIG. 6 is a timing chart that shows an example of a timing for setting a brake pressure release permission flag to ON.

FIG. 7 is a timing chart that shows another example of a timing for setting the brake pressure release permission flag to ON.

### DESCRIPTION OF THE PREFERRED EMBODIMENTS

Hereinafter, embodiments of the present invention will be described in detail with reference to the accompanying drawings.

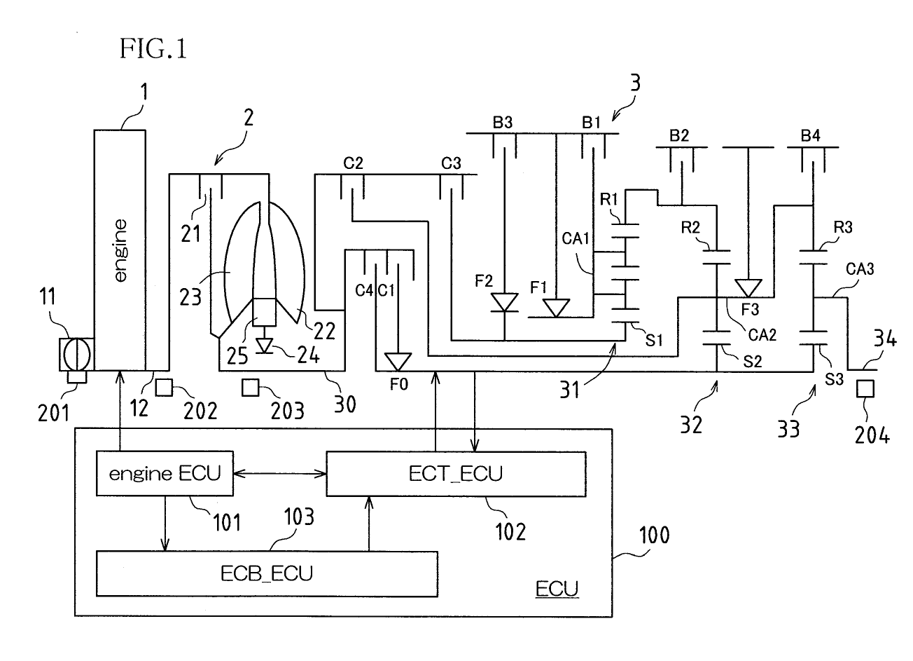

A powertrain of a vehicle that includes the control apparatus of the present invention will be described with reference to FIG. 1. The control apparatus of the vehicle in this example is realized by a program executed by an ECU (Electronic Control Unit) 100 shown in FIG. 1.

As shown in FIG. 1, the powertrain of this vehicle is configured from an engine 1, a torque converter 2, an automatic transmission 3, and the ECU 100. Each portion of the engine 1, the torque converter 2, the automatic transmission 3, and the ECU 100 will be described below.

### (Engine)

The amount of air sucked into the engine 1 is adjusted by an electronically controlled throttle valve 11. The throttle valve 11 is capable of electronically controlling a throttle opening degree independent of operation of an accelerator pedal by a driver, and that opening degree (the throttle opening degree) is detected by a throttle opening degree sensor 201. A crank shaft 12 that is an output shaft of the engine 1 is connected to an input shaft of the torque converter 2. The number of revolutions of the crank shaft 12 (a number of engine revolutions Ne) is detected by an engine revolutions sensor 202.

### (Torque Converter/Automatic Transmission)

The torque converter 2 is provided with a lock-up clutch 21 that puts the input shaft and the output shaft in a directly coupled state, an input-side pump impeller 22, an output-side turbine impeller 23, a one-way clutch 24, and a stator 25 that manifests a torque amplification function. The torque converter 2 and the automatic transmission 3 are connected by a rotating shaft. A number of turbine revolutions Nt of the torque converter 2 is detected by a turbine revolutions sensor 203.

The automatic transmission 3 is a planetary gear-type transmission provided with a double pinion-type first planetary gear apparatus 31, a single pinion-type second planetary gear apparatus 32, and a single pinion-type third planetary gear apparatus 33.

A sun gear S1 of the first planetary gear apparatus 31 is selectively linked to an input shaft 30 via a clutch C3. Also, the sun gear S1 is selectively linked to a housing via a one-way clutch F2 and a brake B3, thus preventing rotation in the reverse direction (direction opposite to rotation of the input shaft 30). A carrier CA1 of the first planetary gear apparatus 31 is selectively linked to the housing via a brake B1, and rotation in the reverse direction is always prevented by a one-way clutch F1, which is provided parallel to the brake B1. A ring gear R1 of the first planetary gear apparatus 31 is linked as a single body with a ring gear R2 of the second planetary gear apparatus 32, and is selectively linked to the housing via a brake B2.

A sun gear S2 of the second planetary gear apparatus 32 is linked as a single body with a sun gear S3 of the third planetary gear apparatus 33, and is selectively linked to the input shaft 30 via a clutch C4. Also, the sun gear S2 is selectively linked to the input shaft 30 via a one-way clutch F0 and a clutch C1, preventing rotation in the reverse direction relative to the input shaft 30. A carrier CA2 of the second planetary gear apparatus 32 is linked as a single body with a ring gear R3 of the third planetary gear apparatus 33, and is selectively linked to the input shaft 30 via a clutch C2, and is selectively linked to the housing via a brake B4. Also, the carrier CA2 is always prevented from rotating in the reverse direction by a one-way clutch F3 provided parallel to the brake B4. A carrier CA3 of the third planetary gear apparatus 33 is linked as a single body to an output shaft 34. A number of revolutions Nout of the output shaft 34 is detected by an output shaft revolutions sensor 204.

In the above automatic transmission 3, a gear (gearshift) is set by engagement or release in a predetermined state of the clutch elements C1 to C4, the brake elements B1 to B4, and the one-way clutch elements F0 to F3, which are frictional elements. It is possible to shift between the shift positions of the automatic transmission 3 by operation of a shift lever or the like.

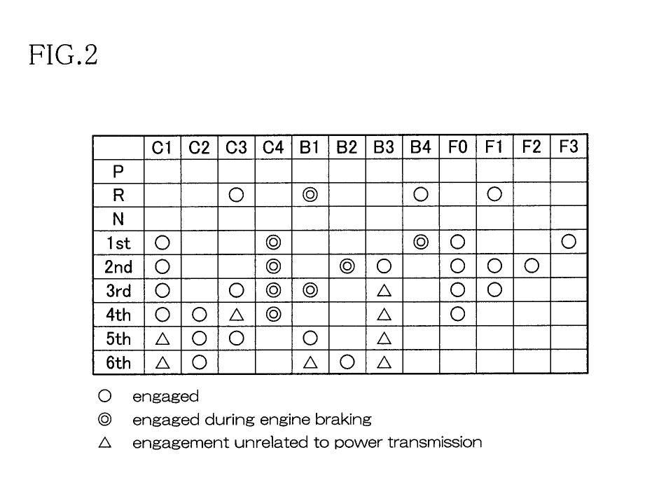

The states of engagement or release of the clutch elements C1 to C4, the brake elements B1 to B4, and the one-way clutch elements F0 to F3 of the automatic transmission 3 are shown in the operation table in FIG. 2. As shown in FIG. 2, for example, in a first gear used when the vehicle begins moving forward, a clutch element (C1) and one-way clutch elements (F0 and F3) engage. Among these clutch elements, the clutch element C1 in particular is referred to as a forward clutch (input clutch). As shown in the operation table in FIG. 2, the forward clutch C1 is definitely used in an engaged state when configuring a gear for the vehicle to move forward, which is other than the parking (P) position, the rearward running (R) position, and the neutral (N) position.

So, in the above automatic transmission 3, when a predetermined neutral control start condition has been established, a neutral control is executed that releases a forward clutch C1 or puts the forward clutch C1 in a predetermined slip state. The neutral control of the automatic transmission 3 is executed by an ECT_ECU 102, the details of which will be described below.

### (ECU)

An ECU 100 that serves as a control unit that controls the above powertrain includes an engine ECU 101 that controls the engine 1, the ECT_ECU (Electronically Controlled automatic Transmission_ECU) 102 that controls the torque converter 2 and the automatic transmission 3, and an ECB_ECU (Electronically Controlled Brake system_ECU) 103 that controls the electronically controlled brake system. As described below, the ECU 100 fulfills the roles of a neutral control unit that executes the neutral control, a brake hold control unit that executes the brake hold control, and an engine torque control unit that adjusts engine torque.

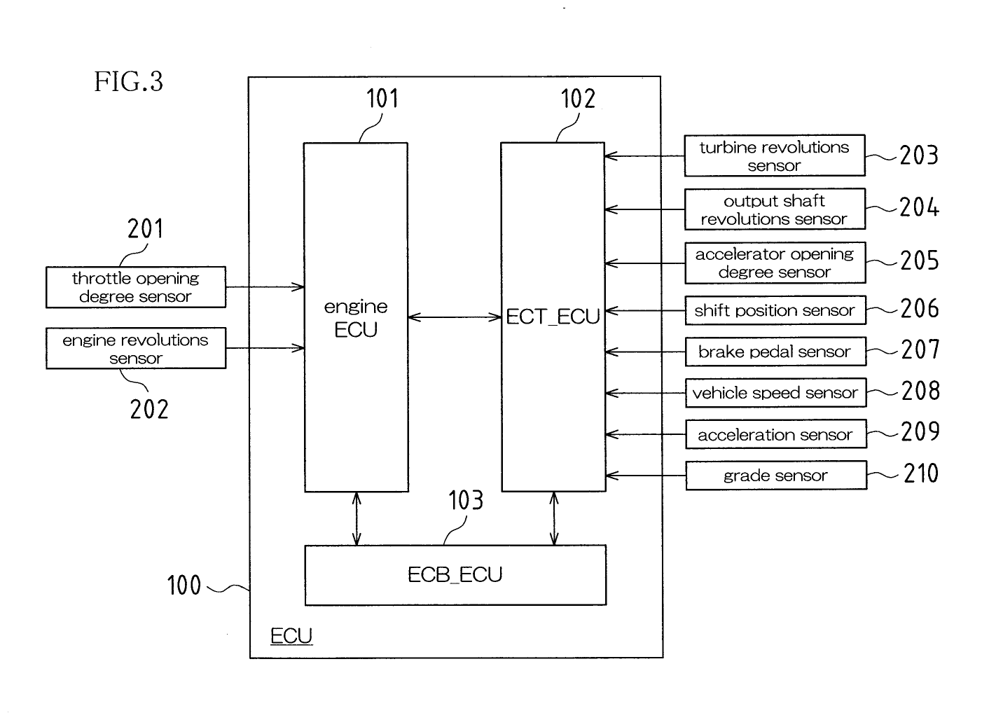

As shown in FIG. 3, the throttle opening degree sensor 201 and the engine revolutions sensor 202, which detect the operational state of the engine 1, are connected to the engine ECU 101, and signals from each of those sensors are input to the engine ECU 101. Also, a brake hold control ON/OFF signal or the like is input from the ECB_ECU 103 to the engine ECU 101.

As shown in FIG. 3, the turbine revolutions sensor 203, the output shaft revolutions sensor 204, an accelerator opening degree sensor 205, a shift position sensor 206, a brake pedal sensor 207, a vehicle speed sensor 208, an acceleration sensor 209, and a grade sensor 210 are connected to the ECT_ECU 102, and signals from each of those sensors are input to the ECT_ECU 102. Also, a brake hold control ON/OFF signal or the like is input from the engine ECU 101 to the ECT_ECU 102.

Further, the ECT_ECU 102 outputs a lock-up clutch control signal to the torque converter 2. Based on this lock-up clutch control signal, an engagement pressure of the lock-up clutch 21 is controlled. Also, the ECT_ECU 102 outputs a solenoid control signal (hydraulic command signal) to the automatic transmission 3. Based on this solenoid control signal, a linear solenoid valve, an on-off solenoid valve, and the like of a hydraulic circuit of the automatic transmission 3 are controlled, so that the clutch elements C1 to C4, the brake elements B1 to B4, and the one-way clutch elements F0 to F3 are engaged or released in a predetermined state so as to configure a predetermined gear (first gear to sixth gear).

The ECB_ECU 103 controls the electronically controlled brake system. The electronically controlled brake system maintains braking force independent of operation of the accelerator pedal by the driver, and is operated during the brake hold control described below, and during braking/stopping of the vehicle during execution of the all vehicle speed cruise control.

The ECT_ECU 102, based on the detection signals of each of the above sensors, sends an engine control signal such as an accelerator opening degree instruction to the engine ECU 101, and sends a brake pressure instruction, a brake pressure release permission flag, or the like to the ECB_ECU 103. Further, the ECT_ECU 102 executes the “brake hold control”, “neutral control”, “all vehicle speed cruise control” and “forward movement start control” described below.

### (Brake Hold Control)

In a situation in which the vehicle is repeatedly stopping and moving forward, such as when there is heavy traffic or when waiting for a traffic light to change for example, the brake hold control is executed with an object of, for example, lightening the burden of the driver continuing to depress the brake pedal.

The brake hold control is executed by the ECB_ECU 103 controlling the electronically controlled brake system based on a command signal such as a brake pressure instruction sent from the ECT_ECU 102 to the ECB_ECU 103, and maintains a stopped state of the vehicle by preserving the vehicle brake pressure even if the driver's foot is removed from the brake pedal after the vehicle stops. This brake hold control is removed when the accelerator enters an ON state, thus releasing the brake pressure of the vehicle wheels. In this example, the brake hold control is executed also when the vehicle is automatically stopped during execution of the all vehicle speed cruise control described below. Also note that conditions for operation of the brake hold control are, for example, that the vehicle speed is “0” based on a vehicle speed detection signal from the vehicle speed sensor 208, the amount of operation of the accelerator pedal is “0” based on output of the accelerator opening degree sensor 205, or the like.

### (Neutral Control)

When a predetermined neutral control start condition has been established, the ECT_ECU 102 controls the hydraulic control circuit of the automatic transmission 3 to release a forward clutch C1 or put the forward clutch C1 in a predetermined slip state, thus putting the automatic transmission 3 in a neutral state (neutral control).

Here, in this example, neutral control start conditions are, for example, that the vehicle speed is “0” based on the vehicle speed detection signal from the vehicle speed sensor 208, the shift lever position is “D range” based on the shift position sensor 206, the brake pedal is being depressed (or the brake hold control is being executed), the amount of operation of the accelerator pedal is “0” based on output of the accelerator opening degree sensor 205, or the like.

The condition for return from the neutral control (return trigger), when returning from the ordinarily neutral control, is for example that “depression of the brake pedal is removed” (the brake pedal sensor 207 is OFF)”. On the other hand, in a circumstance in which the brake hold control and the neutral control are executed at the same time, the condition for returning from the neutral control is “accelerator ON”. Also, the condition for returning from the neutral control during execution of the all vehicle speed cruise control (during execution of the brake hold control) is “accelerator ON” or “operation of the resume lever”.

### (All Vehicle Speed Cruise Control)

When a cruise control switch is set to ON, the ECT_ECU 102 executes the all vehicle speed cruise control. Specifically, for example with a millimeter-wave radar apparatus, detection of whether or not there is a vehicle in front, the inter-vehicle distance to the vehicle in front, and the like are performed, and when there is a vehicle in front, so as to run following that vehicle or so as to stop, engine torque is adjusted by controlling the throttle opening degree of the throttle valve 11 of the engine 1, and the vehicle braking force is adjusted by controlling the brake pressure of the electronically controlled brake system (ECB).

As stated above, the all vehicle speed cruise control is a driving support system that, when the vehicle is running on a highway or a road for automobiles only, in a wide range from 0 km/h to about 100 km/h, runs the vehicle so as to follow a preceding vehicle while keeping an appropriate inter-vehicle distance from the preceding vehicle. Also, with the all vehicle speed cruise control, it is possible to lighten the driver's burden of operating the accelerator or the brake not only during running at a fixed speed, but also in a situation such as stop-and-go driving when there is heavy traffic. Moreover, when the preceding vehicle that is being followed has stopped, a stopped state is maintained that keeps an appropriate inter-vehicle distance, and when recognizing that the preceding vehicle has started to move again, it is possible to resume running following the preceding vehicle by the driver operating a resume lever or operating the accelerator pedal to an ON state.

### (Forward Movement Start Control)

Next is a description of a forward movement start control performed when starting to move the car forward, from a circumstance in which the brake hold control and the neutral control are executed at the same time.

First, when the neutral control is being executed during execution of the brake hold control, there may be an instance in which the driver's foot is removed from the brake pedal while the vehicle is stopped, so the condition for returning from the neutral control cannot be the ordinary condition that “depression of the brake pedal is removed”. Thus, as stated above, the return from the neutral control is started using accelerator ON as a condition.

When, in this manner, the return from the neutral control is started using accelerator pedal ON as a condition, there is the problem that a shock occurs when returning from the neutral control, so drivability decreases. Also during execution of the all vehicle speed cruise control, if accelerator ON or operation of the resume lever is used as the condition for returning from the neutral control during execution of the brake hold control, a shock occurs when returning from the neutral control.

Also, when the brake hold control and the neutral control are executed at the same time, if the return from the neutral control is performed using accelerator ON as a condition, the return from the brake hold control is also performed at the same time by that accelerator ON. When, in this manner, the start of the return from the neutral control and the return from the brake hold control (the start of the release of brake pressure) are performed at the same time, the brake pressure is released earlier than the engagement of the forward clutch C1 of the automatic transmission 3, so when the vehicle begins moving forward on a sloped road (when ascending), there is a risk that it will not be possible to obtain adequate creeping force, and the vehicle will move backward.

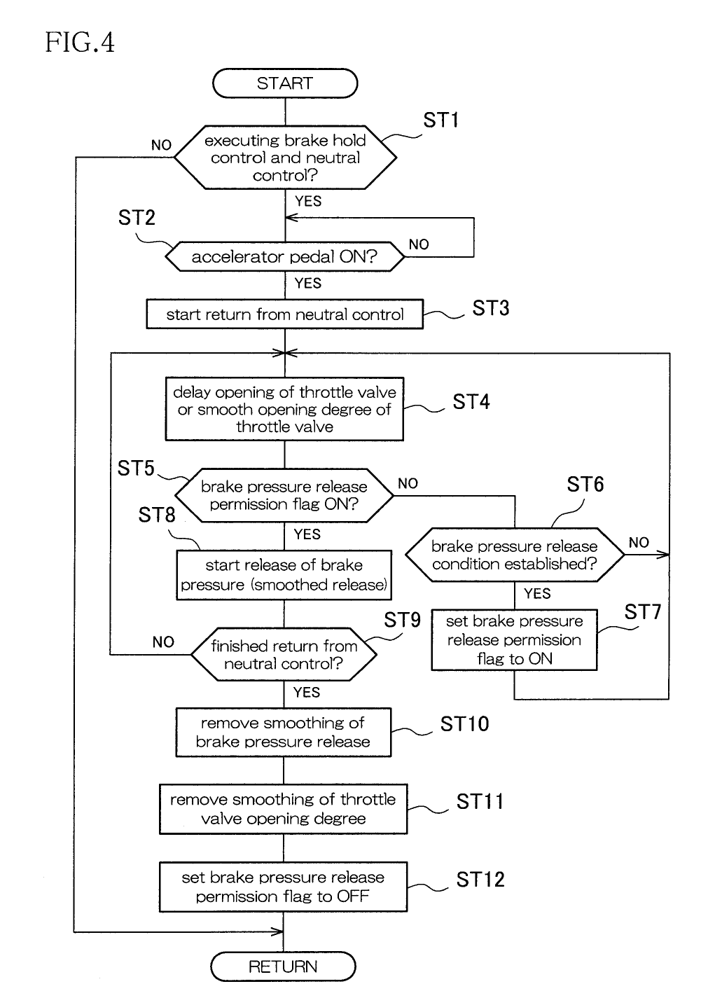

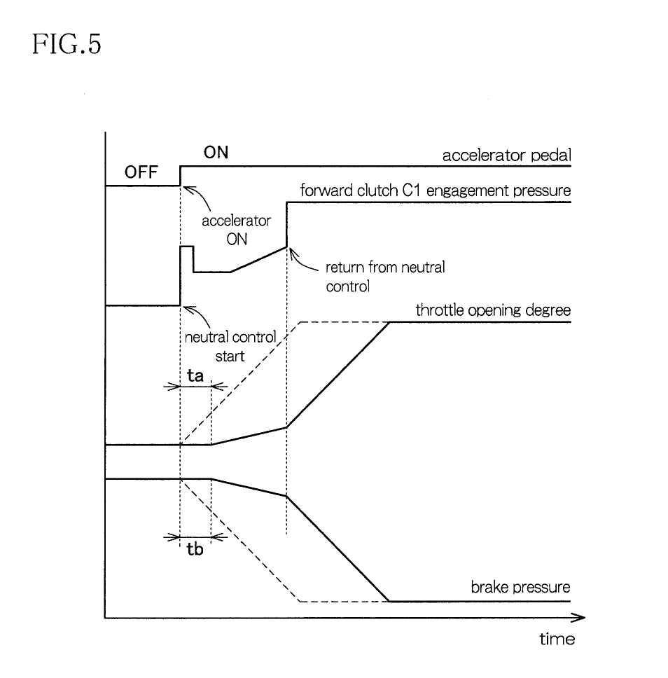

In consideration of the above points, in this example, in a circumstance in which the brake hold control and the neutral control are executed at the same time, when the accelerator has been operated ON (demanding to start forward vehicle movement), by appropriately setting the timing and manner of opening the throttle valve 11 of the engine 1, and the release timing and release slope of the brake pressure, a shock is suppressed when returning from the neutral control, and backward movement of the vehicle is prevented. That specific control (the forward movement start control) will be described with reference to the flow chart in FIG. 4 and the timing chart in FIG. 5. A forward movement start control routine in FIG. 4 is repeatedly executed in the ECT_ECU 102 at each of a predetermined time.

First, in Step ST1, a determination is made of whether or not in the present circumstance the brake hold control is being executed, and the neutral control is being executed, and when the result of that determination is negative, this routine is temporarily not performed. When the result of the determination in Step ST1 is affirmative, the routine advances to Step ST2.

In Step ST2, a determination is made of whether or not the accelerator pedal has been operated (accelerator ON) based on the output signal of the accelerator opening degree sensor 205, and when the result of that determination is affirmative (in the case of accelerator ON (a demand to start forward vehicle movement)), the return from the neutral control is started (Step ST3). As shown in FIG. 5, during the return from the neutral control, the engagement pressure (hydraulic command value) of the forward clutch C1 of the automatic transmission 3 is temporarily raised to an initial engagement pressure, then maintained at a low standby pressure, and then raised with a fixed slope.

Next, in Step ST4, at a point in time delayed a predetermined time ta (see FIG. 5) from the start of the return from the neutral control (when the accelerator is operated ON), an accelerator opening degree instruction is sent from the ECT_ECU 102 to the engine ECU 101, and the engine ECU 101 opens the throttle valve 11 of the engine 1. At this time, the manner of opening the throttle valve 11 (slope of the increase in engine torque) is limited, and is smoother (smoothed opening degree of the throttle valve 11) than in a conventional control (the throttle opening degree indicated by the broken line in FIG. 5). By smoothing the opening degree of the throttle valve 11 in this manner, it is possible to smoothly increase the output torque of the engine 1. Also, timing and manner of opening the throttle valve 11 during the return from the neutral control is always the same, regardless of the amount of depression of the accelerator pedal by the driver when starting forward vehicle movement.

Further, after starting the return from the neutral control, in Step ST5 a determination is made of whether or not the brake pressure release permission flag is ON, and when the result of that determination is negative, the routine advances to Step ST6, and a determination is made of whether or not a brake pressure release condition has been established. In this example, a determination of whether or not a predetermined set length of time tb (see FIG. 5) has passed since the point in time that the return from the neutral control started, and when the result of that determination is negative, in a state with the brake pressure release permission flag set to OFF, the routine returns to Step ST4. After returning to Step ST4, when the delay time ta has not passed, in that state the delay process continues, and when the delay time ta has passed, processing to smooth the opening degree of the throttle valve 11 is executed.

On the other hand, when the result of the determination in Step ST6 is affirmative, i.e., when the set length of time tb has passed since the return from the neutral control, so that the brake pressure release condition has been established, the brake pressure release permission flag is set to ON (Step ST7), and then the routine returns to Step ST4. Here, the set length of time tb is obtained through experience, by performing advance testing, calculation, and the like of the length of time from the start of the return from the neutral control until the forward clutch C1 has adequate engaging force to prevent backward vehicle movement, and set to an appropriate value based on those results.

Then, at the point in time that the brake pressure release permission flag has been set to ON, a brake pressure instruction and a brake pressure release permission flag are sent from the ECT_ECU 102 to the ECB_ECU 103, and the ECB_ECU 103 starts release of brake pressure (Step ST8). However, during the operation to return from the neutral state, the slope of the release of brake pressure is made smoother (smoothed release of brake pressure) than in a conventional control (the slope of the release of brake pressure indicated by a broken line in FIG. 5).

The processing in each of the above Steps ST4 to ST8 is repeated in order until the return from the neutral control ends. Then, at the point in time that the return from the neutral control ends, i.e. at the point in time that the forward clutch C1 of the automatic transmission 3 is completely engaged (the point in time that the result of the determination in Step ST9 is affirmative), in Step ST10, processing to smooth the release of brake pressure is removed, and thus brake pressure is released with an ordinary release slope. Further, in Step ST11, processing to smooth the opening degree of the throttle valve 11 is removed, and thus the throttle valve 11 is opened in an ordinary manner. Afterward, the brake release permission flag is set to OFF (Step ST12), and this routine is temporarily ended.

According to the above forward movement start control, when, in a circumstance in which the brake hold control and the neutral control are being executed at the same time, the driver operates the accelerator ON and begins to move the vehicle forward, the throttle valve 11 is smoothly opened after passage of a predetermined length of time since starting the return from the neutral control, so it is possible to suppress an early increase in engine torque. In this manner, regardless of the amount that the accelerator pedal is depressed by the driver, an early increase in engine torque is suppressed when returning from the neutral control, and the environment (such as the torque produced) when returning from the neutral control is made to always be the same, so it is easy to adapt to the engagement hydraulics of the forward clutch C1, and thus it is possible to suppress a shock when returning from the neutral control.

Further, brake pressure also is released smoothly after passage of a predetermined length of time since starting the return from the neutral control, so it is possible to preserve braking force during the return from the neutral control. Accordingly, by combining the controls to release brake pressure in this manner, it is possible to more effectively suppress a shock when returning from the neutral control.

Also, in the forward movement start control of this example, the release of braking force is not started immediately after starting the return from the neutral control; rather, the release of braking force is started at the point in time that the predetermined set length of time tb has passed since starting the return. Therefore, it is possible to preserve braking force until the forward clutch C1 has adequate engaging force to prevent backward vehicle movement, and thus it is possible to prevent backward movement when the vehicle begins moving forward on a sloped road (when ascending).

Also, the above forward movement start control is executed when, in a circumstance in which the brake hold control and the neutral control are being executed during execution of the all vehicle speed cruise control, there has been a demand to start forward vehicle movement, i.e. when the accelerator has been operated ON or the resume lever has been operated.

Here, with respect to the parameters used for the above forward movement start control, i.e., the four parameters of the timing (delay time ta) and manner (smoothed opening degree) of opening the throttle valve 11, and the timing (set delay time tb) and slope (smoothed release) for releasing brake pressure are set to appropriate values obtained through experience by performing advance testing, calculation, and the like, so as to achieve suppression of a shock when returning from the neutral control, and prevention of backward vehicle movement on a sloped road (when ascending).

Also, the set delay time tb of the timing for the release of brake pressure may be a fixed value, or may be varied according to an inclined state of the vehicle obtained from output of the grade sensor 210.

### Other Embodiments

In the above example, when the vehicle begins moving forward, the four parameters of the timing and manner of opening the throttle valve 11, and the timing and slope for releasing brake pressure, are controlled, but the present invention is not limited to such a configuration. For example, it is possible to adopt a configuration in which an early increase in engine torque when the vehicle begins moving forward is prevented by controlling either one or both of the timing and manner of opening the throttle valve 11. Also, the manner of opening the throttle valve 11 and the timing for releasing brake pressure may be controlled.

In the above example, when returning from the neutral control, the timing for setting the brake pressure release permission flag, which permits the release of brake pressure, to ON is the point in time that the predetermined set length of time tb has passed since the return from the neutral control, but the present invention is not limited to such a configuration.

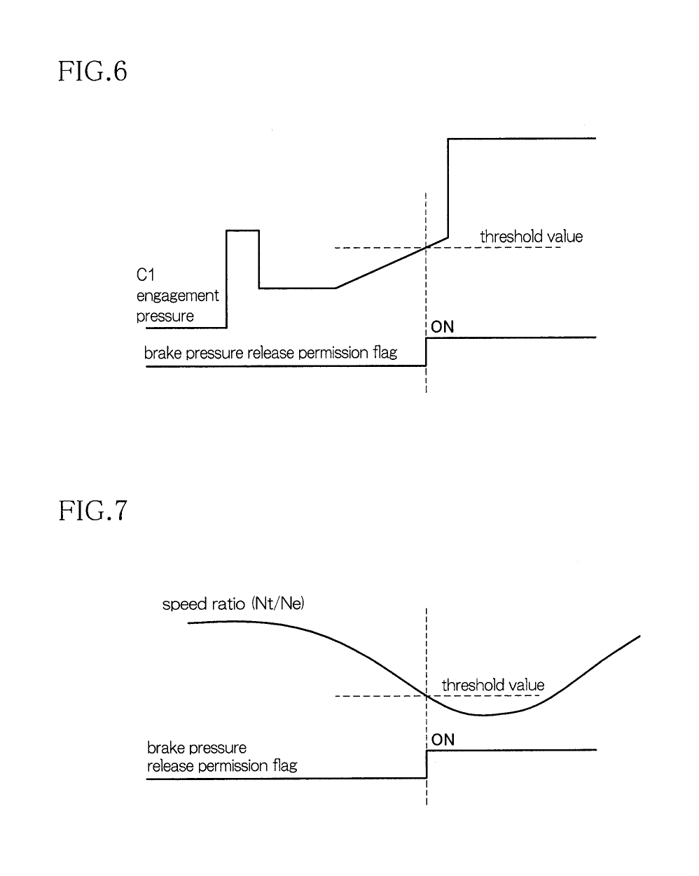

For example, a method is possible in which, as shown in FIG. 6, the brake pressure release permission flag is set to ON when the engagement pressure (hydraulic command value) of the forward clutch C1 of the automatic transmission 3 is equal to or greater than a predetermined threshold value. Also, a method is possible in which, as shown in FIG. 7, the brake pressure release permission flag is set to ON when a speed ratio [number of turbine revolutions Nt/number of engine revolutions Ne] of the number of turbine revolutions Nt obtained from the output of the turbine revolutions sensor 203 to the number of engine revolutions Ne obtained from the output of the engine revolutions sensor 202 is equal to or less than a threshold value.

Also, in these methods, the threshold value that is set for the engagement pressure (hydraulic command value) of the forward clutch C1, and the threshold value that is set for the speed ratio [Nt/Ne] of the number of turbine revolutions Nt to the number of engine revolutions Ne, are each set to a value obtained through experience by performing advance testing, calculation, and the like, such that the forward clutch C1 can engage adequately to prevent backward vehicle movement. Also, each threshold value may be a fixed value, or each threshold value may be varied according to the inclined state of the vehicle obtained from output of the grade sensor 210.

In the above example, a description was given of a control apparatus in a vehicle equipped with an automatic transmission having a planetary gear-type transmission mechanism, but the present invention is not limited to such a configuration; for example, the present invention is also applicable to a control apparatus in a vehicle equipped with a belt-type gearless transmission (CVT).

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

This application claims priority under 35 U.S.C. § 119(a) on Japanese Patent Application No. 2006-316968 filed in Japan on Nov. 24, 2007, the entire contents of which are hereby incorporated by reference. Moreover, documents referred to in the present specification are specifically incorporated in their entirety.

1. A control apparatus for a vehicle comprising an internal combustion engine and an automatic transmission having a forward clutch that is engaged when the vehicle starts moving forward, the vehicle control apparatus comprising:
a neutral control unit that executes a neutral control that sets power transmission of the forward clutch to not more than a predetermined value while the vehicle is stopped,
a brake hold control unit that executes a brake hold control that preserves braking force of the vehicle regardless of operation of a brake pedal, and
an engine torque control unit that, in a circumstance in which the neutral control is being executed during execution of the brake hold control, when there has been a demand to start forward vehicle movement, starts a return from the neutral control, and when returning from the neutral control, smoothly increases the engine torque of the internal combustion engine regardless of an accelerator opening degree.

2. The vehicle control apparatus according to claim 1, wherein the engine torque control unit delays the start of increasing the engine torque of the internal combustion engine for a predetermined length of time after the point in time that there was a demand to start forward vehicle movement.

3. The vehicle control apparatus according to claim 1, wherein during the return from the neutral control, the engine torque control unit limits a slope of the increase in the engine torque of the internal combustion engine to not more than a predetermined value.

4. The vehicle control apparatus according to claim 2, wherein during the return from the neutral control, the engine torque control unit limits a slope of the increase in the engine torque of the internal combustion engine to not more than a predetermined value.

5. The vehicle control apparatus according to claim 1, wherein during the return from the neutral control, the brake hold control unit preserves the braking force of the vehicle.

6. The vehicle control apparatus according to claim 2, wherein during the return from the neutral control, the brake hold control unit preserves the braking force of the vehicle.

7. The vehicle control apparatus according to claim 3, wherein during the return from the neutral control, the brake hold control unit preserves the braking force of the vehicle.

8. The vehicle control apparatus according to claim 4, wherein during the return from the neutral control, the brake hold control unit preserves the braking force of the vehicle.

9. The vehicle control apparatus according to claim 5, wherein during the return from the neutral control, the brake hold control unit limits a slope of release of braking force to not more than a predetermined value.

10. The vehicle control apparatus according to claim 6, wherein during the return from the neutral control, the brake hold control unit limits a slope of release of braking force to not more than a predetermined value.

11. The vehicle control apparatus according to claim 7, wherein during the return from the neutral control, the brake hold control unit limits a slope of release of braking force to not more than a predetermined value.

12. The vehicle control apparatus according to claim 8, wherein during the return from the neutral control, the brake hold control unit limits a slope of release of braking force to not more than a predetermined value.

13. The vehicle control apparatus according to an) of claims claim 5, wherein the brake hold control unit starts to release brake pressure at a point in time that a predetermined length of time has passed since there was a demand to start forward vehicle movement.

14. The vehicle control apparatus according to claim 5, wherein the brake hold control unit starts to release the brake pressure according to engagement pressure of the forward clutch.

15. The vehicle control apparatus according to claim 5, wherein the brake hold control unit starts to release the brake pressure according to a speed ratio of a number of turbine revolutions of a torque converter provided in the automatic transmission and a number of engine revolutions of the internal combustion engine.
